(19) United States
(12) Patent Application Publication
(10) Pub. No.: US 2015/0143964 A1
(43) Pub. Date: May 28, 2015

(54) Drain Trim Ring Installation and Uninstallation Device

(71) Applicants: Glen Kanczewski, Franklin, WI (US); Ken Kanczewski, Oak Creek, WI (US)

(72) Inventors: Glen Kanczewski, Franklin, WI (US); Ken Kanczewski, Oak Creek, WI (US)

(21) Appl. No.: 14/481,860

(22) Filed: Sep. 9, 2014

Related U.S. Application Data
(60) Provisional application No. 61/875,325, filed on Sep. 9, 2013.

(51) Int. Cl. B25B 13/54

(52) U.S. Cl. CPC B25B 13/54
USPC 81/436

(57) ABSTRACT

A device for both installing and uninstalling a drain trim ring. The device comprises a body, a flange, and a male drive. The length of the body corresponds to the interior diameter of a trim ring, thereby creating fitment therebetween and holding the device securely in place within the trim ring. After the device has been inserted into a trim ring, an individual can then apply rotational force to the device via a socket wrench, or other such device, applied to the male drive. The rotational force applied to the device is then applied to the trim ring due to the frictional engagement between the device and the trim ring, thereby allowing the trim ring to be screwed into or out of the corresponding drain shoe.

### CROSS REFERENCE TO RELATED APPLICATION

This application claims the benefit of U.S. Provisional Application No. 61/875,325 filed on Sep. 9, 2013. The above identified patent application is herein incorporated by reference in its entirety to provide continuity of disclosure.

### BACKGROUND OF THE INVENTION

### Field of the Invention

The present invention relates to plumbing tools. More specifically, the present invention relates to devices adapted to assist in installing a drain trim ring.

Drain trim rings, also known as drain flanges, serve as the water tight connection between the water pipes beneath a sink and the drain portion of a sink, bathtub, or other such device. Without a watertight connection, water would freely leak from the sink or bathtub into the area thereunder. Installing and removing the trim ring in a conventional household sink is a relatively simple task because individuals can simply access the bottom of the sink and unscrew the underlying pipe fitting. However, installing and removing the trim ring for bathtubs and sinks where one is unable to access the underlying pipe fitting, such as commercial sinks used in many restaurants, is a much more difficult task because the designs of trim rings makes them difficult to grasp and screw into the pipe fitting connected to the drain. Therefore, individuals often use pliers and other such devices to maintain a consistent, firm grip on the trim ring as it is screwed in. However, using pliers in this way can result in scratches and other types of damage to the trim ring and the surrounding bathtub or sink. Therefore, there is a need in the prior art for a device that is adapted for installing and uninstalling a drain trim ring, especially for drains where the underlying pipes are inaccessible.

### DESCRIPTION OF THE PRIOR ART

Devices have been disclosed in the prior art that relate to drain trim ring installation and removal devices. These include devices that have been patented and published in patent application publications. These devices generally relate to drain keys and other such devices. The following is a list of devices deemed most relevant to the present disclosure, which are herein described for the purposes of highlighting and differentiating the unique aspects of the present invention, and further highlighting the drawbacks existing in the prior art.

Drain keys comprise a plurality of notches that are adapted to engage the open portions of a drain's strainer, thereby allowing individuals to impart a rotational force upon the drain components without having to attempt to grip the portion of the drain that rests flush against the surface of the sink or bathtub. These types of drain keys are only usable for trim rings that have an integral strainer attached thereto. If the strainer is a separate component or the drain simply lacks a strainer, as is the case with many commercial sinks, then drain keys are useless to assist in installing the trim ring.

Some types of drain wrenches comprise an elongated member that is adapted to engage with a pair of aligned notches disposed on the interior surface of a drain trim ring. When inserted into the notches, users are able to impart a rotational force upon the drain trim ring, thereby providing a means to install and uninstall a drain. However, these types of drain wrenches are useless unless the drain trim ring has the proper notches that are sized for the type of drain wrench being used.

The present drain trim ring installation and uninstallation device comprises a body, a flange, and a male drive. The length of the body corresponds to the interior diameter of a trim ring, thereby creating fitment therebetween and holding the device securely in place within the trim ring. After the device has been inserted into a trim ring, an individual can then apply rotational force to the device via a socket wrench, or other such device, applied to the male drive. The rotational force applied to the device is then applied to the trim ring due to the frictional engagement between the device and the trim ring, thereby allowing the trim ring to be screwed into or out of the corresponding drain shoe. The present invention is usable on drain trim rings regardless of whether they have a strainer integrally attached thereto or notches disposed on the interior surface of the trim ring because the present invention utilizes a frictional engagement between the ends of the body portion and the interior surface of the trim ring, rather than a notch and slot mechanism as used by the aforementioned devices.

The present invention substantially diverges in design elements from the prior art and consequently it is clear that there is a need in the art for an improvement to existing drain installation and uninstallation devices. In this regard the instant invention substantially fulfills these needs.

### SUMMARY OF THE INVENTION

In view of the foregoing disadvantages inherent in the known types of drain installation and uninstallation devices now present in the prior art, the present invention provides a new drain installation and uninstallation wherein the same can be utilized for providing convenience for the user when installing or uninstalling a drain trim ring, especially in commercial sink drains.

It is therefore an object of the present invention to provide a new and improved drain trim ring installation and uninstallation device that has all of the advantages of the prior art and none of the disadvantages.

It is another object of the present invention to provide a drain trim ring installation and uninstallation device that is adapted to install or remove a drain trim ring without causing damage thereto or to the surrounding sink or bathtub.

Another object of the present invention is to provide a drain trim ring installation and uninstallation device that is driven by a socket wrench or other such device.

Yet another object of the present invention is to provide a drain trim ring installation and uninstallation device that is composed of a unitary piece of material.

Yet another object of the present invention is to provide a drain trim ring installation and uninstallation device that is adapted for use with commercial sinks, as are commonly used in restaurants.

Still yet another object of the present invention is to provide a drain trim ring installation and uninstallation device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows perspective view of the present invention

FIG. 2 shows a reverse perspective view of the present invention.

FIG. 3 shows a side elevation view of the present invention.

FIG. 4 shows a top view of the present invention.

FIG. 5 shows a bottom view of the present invention.

FIG. 6 shows an exploded view of the present invention aligned with a drain flange and a socket wrench.

### DETAILED DESCRIPTION OF THE INVENTION

Reference is made herein to the attached drawings. Like reference numerals are used throughout the drawings to depict like or similar elements of the drain trim ring installation and removal device. For the purposes of presenting a brief and clear description of the present invention, the preferred embodiment will be discussed as used for installing and removing the trim ring from a commercial sink, bathtub, or other such device. The figures are intended for representative purposes only and should not be considered to be limiting in any respect.

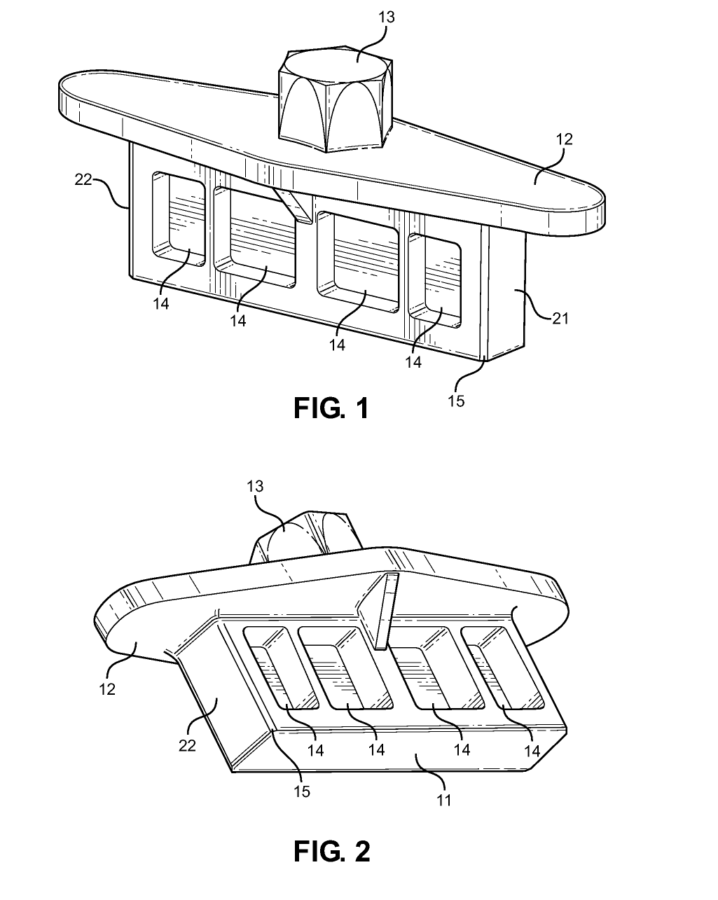

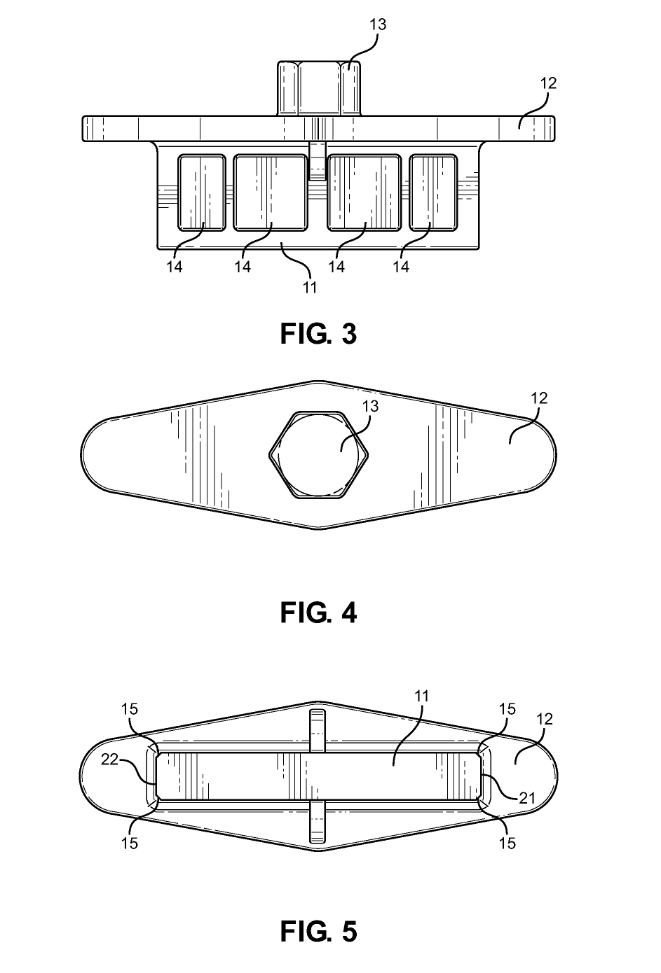

Referring now to FIGS. 1-5, there are shown perspective, side, top, and bottom views of the present invention. The present invention is adapted for installing and removing the trim ring, also known as a drain flange, from the drain of a commercial sink, a bathtub, or another such device without causing damage to the trim ring. The present invention comprises a generally rectangular body 11 having a pair of opposing ends 21, 22, a flange 12, and a male drive 13. The present invention is preferably a unitary structure, which increases the overall strength of the device. The present invention is constructed from injection-molded plastic that is adapted to resist the torque applied to the device via a wrench when it is secured within a drain trim ring, or other such suitable material. The present invention further comprises a series of recesses 14 disposed about the body 11. The recesses 14 increase the tensile strength of the present invention, thereby allowing more torque to be applied to the present invention without causing it to deform permanently.

The base 11 has a length substantially equal to the interior diameter of a conventional drain trim ring, which is 3.5 inches for many commercial sinks. However, the base 11 may be provided in any length so that it conforms to any type or size of trim ring. Because the present invention is adapted for use with a specifically sized trim ring, this ensures that there is fitment between the opposing ends 21, 22 of the base 11 and the notches disposed about the inner diameter of the trim ring. This frictional engagement between the opposing ends 21, 22 and the trim ring holds the present invention securely in place and allows torque applied to the male drive 13 to be transferred to the trim ring without the present invention slipping or freely rotating therein.

The flange 12 serves a dual purpose. First, the flange 12 acts as a physical obstruction preventing the present invention from being inserted too deeply into a trim ring when in use. If the present invention was inserted too deeply into a trim ring, then it could be overly cumbersome to retrieve or it may prevent a wrench from being able to make contact with the male drive 13. Second, it provides a grip that may be grasped by an individual to assist in removing the device from a trim ring after the trim ring has been installed into the drain shoe.

As depicted, the male drive 13 is a male drive having a hexagonal head that can be actuated by a corresponding female socket wrench, open-end wrench, or other such device. However, the depicted embodiment is intended to be merely exemplary and no claim is made as to a specific types of male drive 13 utilized by the present invention. In an alternative embodiment, the present invention comprises a female socket, rather than a male drive 13 as shown.

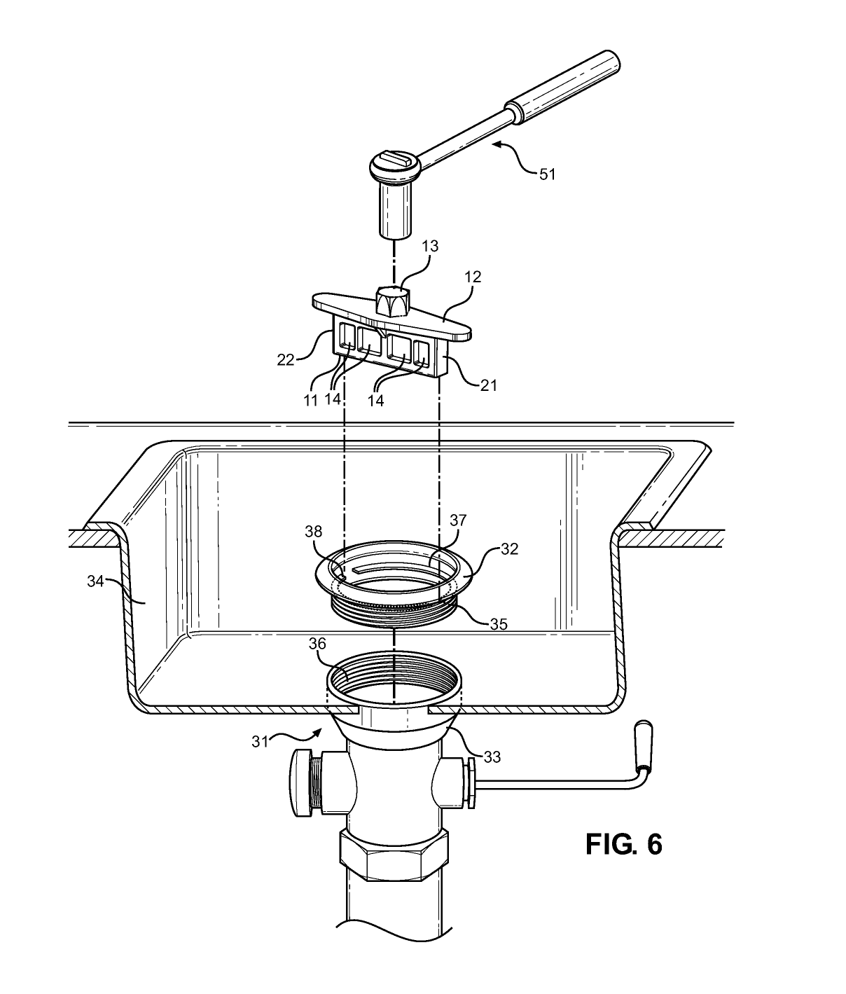

Referring now to FIG. 6, there is shown an exploded view of the present invention aligned with a drain, a trim ring, and a socket wrench. The present invention may be utilized to both install and remove a trim ring 32 from a drain 31. In use, the present invention is inserted into the open interior of a drain trim ring 32. The opposing ends 21, 22 of the body 11 portion of the present invention are insertable into opposing notches 38 disposed about the interior surface 37 of the trim ring 32 and bear thereagainst. The length of the body 11 is substantially equal to the interior diameter of the trim ring 32, thereby ensuring a tight fit therein. The device fits tightly enough such that when torque is applied to the present invention via a socket wrench 51, or other such device, the opposing ends 21, 22 do not slip from the trim ring interior surface 37 and maintain a frictional engagement with the notches 38 disposed thereon. Therefore, torque applied to the present invention through the male drive 13 is transferred to the trim ring 32, causing the entire assembly of the trim ring 32 and the present invention to rotate, rather than causing the present invention to rotate independently of the trim ring 32.

If an individual is installing a trim ring 32 to the open end of a drain 31, the individual first secures the present invention within the trim ring 32 as described herein. After the present invention is secured within the notches 38 disposed oppositely to each other within the trim ring 32 open interior, the trim ring 32 is then placed on the open end of the drain shoe 33. The individual then applies a rotational force to the present invention via a socket wrench 51, or other such device. This causes the entire assembly of the trim ring 32 and the present invention to rotate, engaging the external threading 35 of the trim ring 32 with the threading 36 of the drain shoe 33 and screwing the trim ring 32 into place within the sink 34. Once secured in place, the individual can then remove the present invention from the trim ring 32. If an individual wishes to remove a trim ring 32 from a drain 31, rather than install a trim ring 32, then the individual simply places the present invention within the notches 38 disposed within the trim ring 32 open interior and applies a reverse rotational force. This unscrews the trim ring 32 from the drain 11. The present invention is specifically adapted to not cause any damage any damage to the trim ring 32, the drain 31, or the sink 34 and allows a trim ring 32 to be installed to the open end of a drain 31 in an efficient and convenient manner. Although depicted as being used to install a trim ring 32 within a sink 34 drain 31, the present invention can be utilized to install trim rings 32 to all types of drains 31, including bathtub drains.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device adapted for installing and removing a drain trim ring, comprising:
a body having a pair of opposing ends;
a flange;
a male drive;
wherein the opposing ends are adapted to engage with an interior surface of a trim ring such that when rotational force is applied to the male drive, the opposing ends do not slip from the trim ring interior surface, thereby transferring the rotational force to the trim ring.

2. The device of claim 1, further comprising:
at least one recesses disposed along said body.

3. The device of claim 1, wherein said male drive comprises a hexagonal head.

4. The device of claim 1, wherein the length of the body is 3.5 inches.
